(19) United States
(12) Patent Application Publication
(10) Pub. No.: US 2026/0080730 A1
(43) Pub. Date: Mar. 19, 2026

(54) SMART LOCK SYSTEM

(71) Applicant: ONES BILISIM TEKNOLOJILER ANONIM SIRKETI, Ankara (TR)

(72) Inventors: Dursun Dogukan GOZEN, Ankara (TR); Engin CAN, Ankara (TR); Gucluhan KUZYAKA, Ankara (TR); Gurol Erkin GURBUZ, Ankara (TR); Onur SIRMATEL, Ankara (TR)

(73) Assignee: ONES BILISIM TEKNOLOJILER ANONIM SIRKETI, Ankara (TR)

(21) Appl. No.: 18/870,832

(22) PCT Filed: Jun. 2, 2023
(86) PCT No.: PCT/TR2023/050516

§ 371 Date: Dec. 2, 2024

(30) Foreign Application Priority Data
Jun. 2, 2022 (TR) 2022/009092

(51) Int. Cl. G07C 9/00

(52) U.S. Cl. CPC G07C 9/00563; G07C 2209/08

(57) ABSTRACT

A smart lock system includes a screen interface, a login panel for users to enter the information defined for the purpose of system activation, a control panel used for checking the entered passwords and activation of the system, and access points moving according to the command given by the control panel.

### CROSS REFERENCE TO THE RELATED APPLICATIONS

This application is the national phase entry of International Application No. PCT/TR2023/050516, filed on Jun. 2, 2023, which is based upon and claims priority to Turkish Patent Application No. 2022/009092, filed on Jun. 2, 2022, the entire contents of which are incorporated herein by reference.

### TECHNICAL FIELD

The present invention relates to the development of a smart lock system that also has the necessary security measures that enable users to unlock the locks and/or locks by using biometric and/or user-defined data and/or activation with any card and/or password that will provide activation.

### BACKGROUND

Although locked door and cabinet systems are widely used, different locking and unlocking methods are used. Users usually use different keys for each door and cabinet, as well as encrypted or biometric authentication methods. The biggest problem experienced in such embodiments is the confusion caused by the use of more than one key. In addition, a different system design is needed for each lock process in the activation process with the use of biometric data, which is another embodiment.

In the invention, the subject of the Canadian patent application numbered CA3101101A1, which is an embodiment in the state of the art, modular data center containing a data room or data center modules in the rooms used as a meeting and waiting room and the lock mechanism to be used at the entrance and exit and the method used to open the lock in order to protect it from unauthorized access and environmental effects are explained. Each of the modular data center and/or data center modules can provide independent secure access to multiple users for different sets of electronic equipment. Safety at all levels can be achieved by mechanical and/or electronic (e.g., fob or biometric) mechanisms. When the operation method of the system is examined, it gives access to the rooms within its authority to the relevant user. It does not contain any information that the system provides the user with more than one right of access within the document. In addition, there is no information on the granting of access for a period of time.

The invention, the subject of the Chinese patent application numbered CN110533806A, which is another embodiment in the state of the art, discloses a method for setting up a smart door lock based on the NB-IoT (Narrowband Internet of Things) protocol and CTID (Cyber Trusted Identity) technologies, which are reliable authentication platforms. This smart door lock system consists of an infrared sensor with an NB-IoT module, a key lock device with an NB-IoT module, a QR code scanner, a CTID electronic ID card, a lock control server, and a business server. The user's mobile phone contains a CTID authentication application. The CTID electronic identity card is a virtual identity received by the user from CTID authentication. The virtual identity given after CTID authentication is a two-dimensional code that contains time information for the unlocking process. The smart door lock scans and sends the QR code to the service server to read the user's CTID network card electronic credentials, i.e., the time-stamped QR code. The service server sends the CTID electronic credentials to the authorized database for authentication of the credentials, and after the authentication is passed, the lock control server controls the unlocking of the smart door. At this point, there is no information in the working content of the relevant system for users to choose from more than one door-opening option.

In the invention, the subject of the Chinese utility model application, which is described in CN211933265U and is another embodiment in the state of the art, a networked common control system of an ammunition arsenal is described. The networked common control system includes a master control computer, an ammunition cabinet network module, a warehouse media management module, a power supply, and a redundant power supply. The general control host is connected via a CAN (Controller Area Network) bus with the ammunition cabinet network module and the warehouse media management module. The Power supply or Backup Power supply provides electrical power for electrical components in a networked common control system of the ammunition weapon store. A general control computer provides a connection with a control platform central computer over Ethernet. Network monitoring management of the ammunition cabinet and environmental monitoring management of the ammunition warehouse are carried out through two independent modules: the ammunition cabinet network module and the warehouse environment management module. Due to the CAN communication protocol used in this invention, communication is provided with single input information transfer. At this point, communication cannot be performed at more than one point.

Finally, the invention, subject of the PCT application WO0152199A2, which is another embodiment in the state of the art, relates to a method and a cabinet arrangement for storing the goods in at least one cabinet with at least one lockable door or vane. The cabinet in question operates through an electronic key system. The electronic key system can be defined in particular by means of numerical or alphanumeric inputs, a smart card, or an electronic key system. The invention relates to a cabinet arrangement comprising a computer-controlled electronic lock system for operating the door or flap lock of the cabinet. The lock system can also be activated with the help of magnetic cards, barcodes, transponder chips, biometric sensors, or mobile radiotelephone. The door of a locker can be opened by a delivery person or recipient through a personal electronic key system for placing items in the locker or removing entrusted items from the locker, respectively. The delivery person or buyer has access. At least the identity data of the delivery person is transmitted to a management computer via a telecommunication network. It is mentioned that the locked cabinets, which are defined specifically for the users, are only given to the control of the users. Multiple unlocking and closing of the use are not mentioned. There is also no information about the limited activation time in terms of security.

### SUMMARY

The object of the present invention is to develop a smart lock system that enables the lock or locks of the relevant door or cabinet door to be opened according to the authorizations of the users.

Another object of the present invention is to develop a smart lock system that enables the opening of the relevant cabinet or door according to the user's preference by showing all the cabinet options that can be accessed by the users on a screen.

Another object of the invention is to develop a smart lock system that provides safety by turning the system off if no selection is made within a certain period of time on the screen where users see the lists of cabinets they can access within their authority.

Another object of the invention is to develop a smart lock system in which users can improve the unlocking action in the system with the help of multiple different biometric data, passwords, mobile identities, or smart cards.

### BRIEF DESCRIPTION OF THE DRAWINGS

The figures and related descriptions used to better explain the biometric authenticated smart lock system developed by the invention are as follows.

FIG. 1 is a schematic view of the smart lock system of the invention.

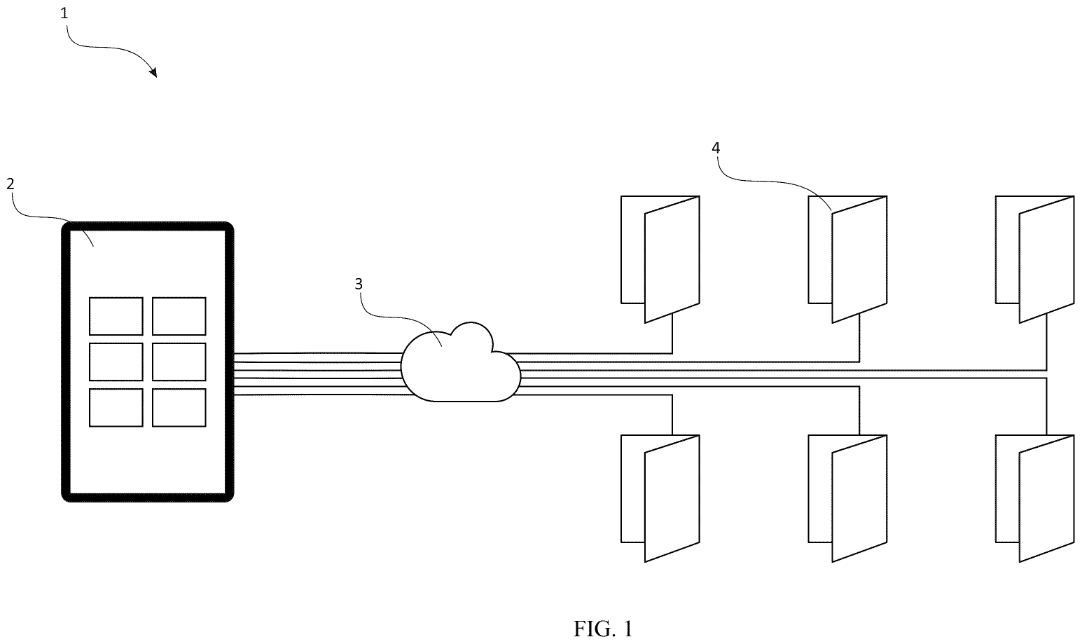

FIG. 2 is a view of the flowchart showing the operating algorithm of the smart lock system of the invention.

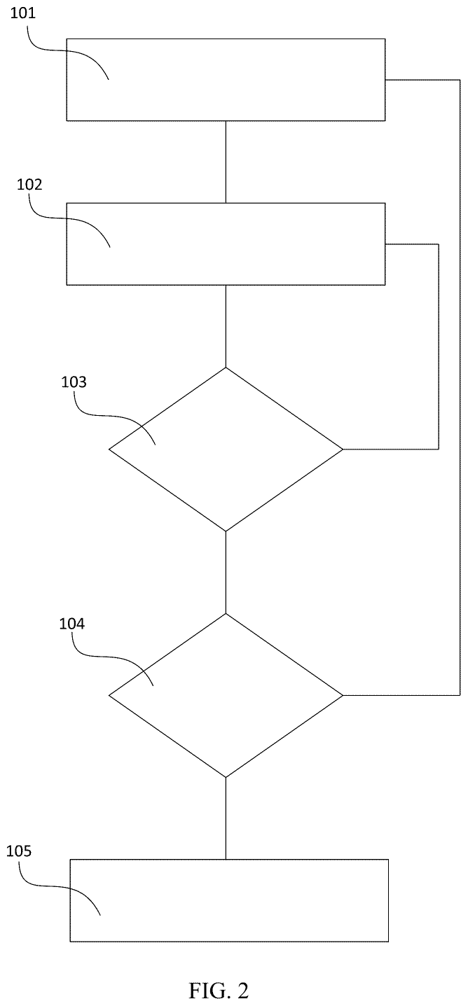

The elements shown in the figures are numbered and their corresponding elements are as follows.
1. Lock system
2. Login panel
3. Control panel
4. Access point

### DETAILED DESCRIPTION OF THE EMBODIMENTS

The invention is basically a smart lock system (1) consisting of a login panel (2) for users to enter the information defined for the purpose of system activation, a control panel (3) used for checking the entered passwords and activation of the system, and multiple access points (4) moving according to the command given by the control panel (3) (in the direction of opening and closing).

The password assigned to them within the framework of the authorizations of the users is entered into the system through a login panel (2). The lock system (2) operates on the basis of the user's authorization. In this context, the data entered through the login panel (2) also enables the definition of the authorization of the user.

The login panel (2) is defined as an alpha-numeric pad in a preferred embodiment of the invention. The login panel (2) can also be designed to allow the input of defined biological data into the user's system. It can be used for palm, fingerprint, and/or retinal scans for users.

The login panel (2) can also be designed as a card reader. Especially in cases where the biological data of the users should not be used, it can contain readers that allow the chip on the identity cards given to the users to the extent of their authorization to be read.

The login panel (2) may accommodate a QR constructor and/or reader. With the help of a mobile application of the users, the data can be verified together with the security steps defined on the relevant application by scanning the QR code on the login panel (2) through a mobile application. In addition, system activation can be performed by entering a mobile application and/or a user's description through a fixed QR code and/or a barcode's login panel (2).

The control panel (3) is the place where the system is activated by processing the request through the login panel (2). After the user makes the desired verification entry through the login panel, this data is transferred to the control panel (3). The relevant verification evaluation is performed on the control panel (3) and the activation is performed.

The control panel (3) enables the unlocking of the access points (4) determined within the framework of the user's authorizations according to the entered verification data. If the user has the authority to open multiple locks, opening all locks at the same time will pose a risk. For this reason, the user who is authorized to open more than one lock will be able to select the lock that they want to be opened through a screen interface that allows them to open the desired lock/door through the control panel (3).

All safety protocols are carried out on the control panel (3). The control panel (3) sees the list of locked zones that the user can access within their authority after entering the relevant data. By default, the user performs the selection within the t1 period. If no selection is made during this “t1” period, the system will turn off the screen, which can be controlled without unlocking. In this way, a second protection is provided.

The operating algorithm of the smart lock system (1) comprises the following steps,
(101) The user enters the required data for system inactivation.
(102) The data entered by the user is transmitted to the control panel (3).
(103) The data is verified.
(104) The right of access to the locks authorized by the user is opened for the “t1” period.
(105) The user selects the lock/door that they want to open within the “t1” period.

It is expected that the user will enter the verification data requested from the first stages of the operation of the smart lock system (1)(101). The verification data may be biometric data such as a palm, retina, and fingerprint, a verification password, and/or an identity card. Verification may also be performed by scanning a QR and/or a barcode through a mobile application. With the user enters the relevant data into the system, the data is transmitted to the control panel (3) with any of the relevant connection protocols (102). The verification of the user's data is performed on the control panel (3)(103). In case user data verification cannot be performed, the system returns to the step of the user entering data (101). With the verification of the user, the access points (4) within its authority are unlocked (104). The user selects the lock/door they want to access within 10 seconds (105). If the user does not intervene in the relevant period, the system returns to the data entry step (101) again.

In a facility where multiple doors/locks are secured, different doors, locks, cabinets, or drawers likely have different levels of security. Multiple doors/locks in a room or corridor may be controlled by the same control panel (3). According to the risk level of this door/lock and the physical distance to the control panel (3), the time to display the unlocking image, i.e., “t2” and the time to keep the lock open, i.e., “t3” may be different.

For example, for a door/lock with a high-risk level, “ty2”, which is the display time of the relevant lock/door opening image on the control panel (3) screen may be as follows;

$$t 1 ≫ ty 2$$

On the other hand, for a door/lock with a low-risk level, “td2”, which is the display time of the relevant lock/door opening image on the control panel (3) screen may be as follows;

$$t 1 = td 2$$

After a user who is authorized to open more than one door/lock has access to the control panel (3), the lock/door unlock images (these images may be indicators such as the codes and colors of the doors/cabinets/drawers with an access point (4)) within their entire authority will be displayed at first and then they will be lost in order according to the risk levels.

On the other hand, after the user requests to unlock the door/lock, the level of risk and the distance of the lock/door to the control panel (3) may vary during the unlocking and unlocking time. For example, in order to open an access point (4) that stands next to the control panel (3), the control panel (3) may trigger in “ty3” time, while for a more distant access point, it may trigger after “tu3”. The relationship between these two times is similar to the physical distance of the two access points (4) to the control panel (3) may be as follows;

$$tu 3 ≫ ty 3$$

In this way, it can be ensured that no one physically closer to the relevant access point than the authorized user cannot access it earlier.

The access points (4) may be a door in embodiments of the invention, such as building security systems. Further, in other embodiments of the invention, the access points (4) may be used as a door and/or similar lockable systems.

What is claimed is:

1. A smart lock system, comprising:
a screen interface, wherein the screen interface displays a list of locked areas in a way that allows a user to select the list of locked areas within a “t1” period and then open a lock/door in case the user is authorized to open multiple locks according to entered verification data,
a login panel, where users are allowed to log in via an alpha-numeric pad with a password allocated to the users within a framework of authorizations of the users,
a control panel used for controlling entered passwords and for performing an activation of the smart lock system, and
multiple access points acting according to a command of the control panel;
wherein the smart lock system is configured to enable unlocking of the locks and/or locks of the users by using biometric and/or user-defined data and/or by providing activation in different options with any card and/or password configured to enable the activation.

2. The smart lock system according to claim 1, wherein the control panel allows the users to log in to the smart lock system through biological data comprising palm, fingerprint, and/or retinal scans, instead of logging in through an alpha-numeric pad with the password allocated to the users within the framework of authorizations of the users.

3. The smart lock system according to claim 1, wherein the control panel allows the users to log in via the user's card instead of logging in via an alpha-numeric pad with the password allocated to the users within the framework of authorizations of the users.

4. The smart lock system according to claim 1, wherein the control panel allows the users to log in with a help of a mobile application containing a QR generator and/or reader instead of logging in via an alpha-numeric pad with the password assigned to the users within the framework of authorizations of the users.

5. The smart lock system according to claim 1, wherein a display time for a respective lock/door opening image on the control panel screen for a door/lock with a high level of risk is t1>>ty2.

6. The smart lock system according to claim 1, wherein a display time of a respective lock/door opening image on the control panel screen for a door/lock with a low-risk level is t1=td2.

7. The smart lock system according to claim 1, wherein an access point is tu3>>ty3, similar to a physical distance to the control panel, during which the control panel triggers for opening an access point standing next to the control panel in a period of “ty3”, while the triggering is performed after a time period of “tu3” for a more distant access point.

8. The smart lock system according to claim 2, wherein a display time for a respective lock/door opening image on the control panel screen for a door/lock with a high level of risk is t1>>ty2.

9. The smart lock system according to claim 3, wherein a display time for a respective lock/door opening image on the control panel screen for a door/lock with a high level of risk is t1>>ty2.

10. The smart lock system according to claim 4, wherein a display time for a respective lock/door opening image on the control panel screen for a door/lock with a high level of risk is t1>>ty2.

11. The smart lock system according to claim 2, wherein a display time of a respective lock/door opening image on the control panel screen for a door/lock with a low-risk level is t1=td2.

12. The smart lock system according to claim 3, wherein a display time of a respective lock/door opening image on the control panel screen for a door/lock with a low-risk level is t1=td2.

13. The smart lock system according to claim 4, wherein a display time of a respective lock/door opening image on the control panel screen for a door/lock with a low-risk level is t1=td2.

14. The smart lock system according to claim 5, wherein a display time of a respective lock/door opening image on the control panel screen for a door/lock with a low-risk level is t1=td2.

15. The smart lock system according to claim 2, wherein an access point is tu3>>ty3, similar to a physical distance to the control panel, during which the control panel triggers for opening an access point standing next to the control panel in a period of “ty3”, while the triggering is performed after a time period of “tu3” for a more distant access point.

16. The smart lock system according to claim 3, wherein an access point is tu3>>ty3, similar to a physical distance to the control panel, during which the control panel triggers for opening an access point standing next to the control panel in a period of “ty3”, while the triggering is performed after a time period of “tu3” for a more distant access point.

17. The smart lock system according to claim 4, wherein an access point is tu3>>ty3, similar to a physical distance to the control panel, during which the control panel triggers for opening an access point standing next to the control panel in a period of “ty3”, while the triggering is performed after a time period of “tu3” for a more distant access point.

18. The smart lock system according to claim 5, wherein an access point is tu3>>ty3, similar to a physical distance to the control panel, during which the control panel triggers for opening an access point standing next to the control panel in a period of “ty3”, while the triggering is performed after a time period of “tu3” for a more distant access point.

19. The smart lock system according to claim 6, wherein an access point is tu3>>ty3, similar to a physical distance to the control panel, during which the control panel triggers for opening an access point standing next to the control panel in a period of “ty3”, while the triggering is performed after a time period of “tu3” for a more distant access point.
